(19) United States
(12) Patent Application Publication
(10) Pub. No.: US 2017/0217312 A1
(43) Pub. Date: Aug. 3, 2017

(54) Active Accelerator Pedal Comprising a Worm Gear

(71) Applicant: Robert Bosch GmbH, Stuttgart (DE)

(72) Inventors: Reiner Schweinfurth, Eppingen (DE); Udo Sieber, Bietigheim (DE); Daniel Henning, Sersheim (DE); Bjoern Noack, Rutesheim (DE); Milos Hlavka, Borovany (CZ)

(21) Appl. No.: 15/501,564

(22) PCT Filed: Jul. 8, 2015
(86) PCT No.: PCT/EP2015/065567

§ 371 Date: Feb. 3, 2017

(30) Foreign Application Priority Data
Aug. 29, 2014 (DE) 10 2014 217 319.1

(51) Int. Cl. B60K 26/02; G05G 5/03; G05G 1/44; F16H 19/00; F02D 11/02

(52) U.S. Cl. CPC B60K 26/021; F16H 19/001; F02D 11/02; G05G 1/44; G05G 5/03; B60K 2026/023; F16H 2019/008

(57) ABSTRACT

An active accelerator pedal for a vehicle includes a pedal unit and an actuator unit. The pedal unit includes a pedal that is pivotable about a pivot axis. The actuator unit includes an electrical device and a worm gear positioned between the electrical drive and the pedal unit. The worm gear includes a worm and a driven worm element. The actuator unit is configured to apply a counterforce in a direction opposite to a pedal force exerted on the pedal.

### STATE OF THE ART

The present invention relates to an active accelerator pedal of a vehicle, comprising a worm gear.

It is possible to use the vehicle pedals in order to provide drivers with tactile feedback on states of the vehicle and changes in those states, so as to indicate hazards and as a pointer to more fuel-efficient driving. The feedback may be applied as a counterforce on the pedal, for example, and may assume various forms, for example a pulsating or vibrating force or a force threshold, depending on a particular situation. Here a counterforce to be exerted on the pedal ranges from 10 to 15 N, there being a need in certain situations for the counterforce to be applied continuously. DE 102011054655 A1, for example, discloses an active accelerator pedal in which the counterforce is applied by means of an electric motor and transmitted to the pedal via a helically toothed gear. This design, however, means that the active accelerator pedal takes up a very large overall space. Particularly in the footwell of a vehicle, however, the overall space is limited and should be used as efficiently as possible.

### DISCLOSURE OF THE INVENTION

The active accelerator pedal of a vehicle according to the invention having the features of claim 1, by contrast, has the advantage that very little overall space is needed and the accelerator pedal is of very simple and cost-effective construction. The invention moreover makes it possible to ensure a high availability of the active accelerator pedal functions. According to the invention this is achieved in that the vehicle active accelerator pedal comprises a pedal unit and an actuator unit. The pedal unit comprises a pedal pivotally arranged on a pivot axis. The actuator unit comprises an electrical drive, in particular an electronically switched direct-current motor, and a worm gear having a worm and a driven worm element. Here the worm gear is arranged between the electrical drive and the pedal unit. The actuator unit is furthermore designed to apply a counterforce in opposition to a pedal force exerted on the pedal (for example by a person). A tactile feedback can therefore be imparted to the driver via the pedal, for example with a view to fuel-efficient driving or, in the case of a hybrid vehicle, a threshold for switching from the electrical drive to an internal combustion engine. The worm gear furthermore has the advantage of a certain irreversibility, so that positions of the actuator unit for generating the counterforce are maintained with only a low power consumption.

The dependent claims show preferred developments of the invention.

The worm gear is preferably of single-step design with just one worm and just one driven worm element, in particular a worm wheel. This serves to minimize the overall dimensions. By adapting the worm gear to suit the particular conditions, it is therefore possible to use a single-step worm gear. It is also possible to provide a two-step or multistep worm gear, thereby enhancing an irreversibility of the worm gear with ever more steps.

Even greater compactness can be achieved if a pivot axis of the pedal and a central axis of a worm wheel coincide. In particular, the worm wheel may preferably be fitted onto a pivot axis of the pedal, allowing an effective integration of the worm gear into the pedal unit.

The pedal unit furthermore preferably comprises a first stop and the actuator unit a second stop. Here the two stops are provided in order to transmit a counterforce applied by the actuator unit to the pedal unit. This affords a simple and robust transmission of force. The provision of an elastic element for damping purposes on one or both stops is especially preferred here.

According to a further preferred development of the invention the active accelerator pedal further comprises a spring element, which is arranged in an operative connection between the worm gear and the pedal. The spring element here is capable of applying an additional force, which is added to the force applied by the actuator unit to produce the required counterforce. The spring element is preferably a compression spring or alternatively a torsion spring. A further advantage of the spring element is that the spring element is capable of absorbing oscillations and therefore has damping characteristics, so that a driver does not detect any unwanted vibrations or the like on the pedal.

The active accelerator pedal preferably further comprises a first travel sensor and a second travel sensor. The first travel sensor here determines a position of a component of the actuator unit movably connected to the worm gear. The second travel sensor determines a position of the pedal of the pedal unit. Where the spring element is used between the pedal unit and the actuator unit it is therefore possible, via a difference between a pedal position and an actuator position, to adjust the required counterforce on the pedal, since the positions define the counterforce applied by the spring element. The force adjustment or force control can therefore be reduced to a pure positional feedback control, so that the control unit can be of very simple and cost-effective construction.

According to a further preferred development of the invention a free travel exists between the worm gear and the pedal unit, wherein the counterforce generated can be applied in opposition to the pedal unit only after covering the free travel. At first, therefore, the actuator unit can be operated without for the time being producing a counterforce acting on the pedal. Only after covering the predefined free travel does the counterforce generated in opposition to the pedal then materialize. This is a simple way of achieving the desired lag in the generation of the counterforce.

The driven worm element is furthermore preferably arranged in a housing of the pedal unit. This affords an especially compact construction. The housing preferably has a window, through which the worm extends and meshes with the worm element. This serves further to increase the compactness of the active accelerator pedal.

The worm gear more preferably comprises a worm wheel having an internal toothing, wherein the worm is arranged inside the worm wheel. This also serves to achieve further compactness. Likewise, the worm wheel more preferably has an external toothing. By doing this the worm can then be positioned at any position along the circumference of the outer wheel, so that the greatest possible flexibility is achieved with regard to the arrangement of the worm and the electrical drive connected to the worm.

A further alternative is for the worm gear to comprise a worm element, which has a worm toothing oriented in an axial direction, which meshes with the worm. This also affords further alternatives with regard to a possible arrangement of components of the active accelerator pedal.

The accelerator pedal further comprises a control unit for operation of the actuator unit, wherein the actuator unit is designed, on the basis of signals from the control unit, to apply a counterforce in opposition to a pedal force exerted on the pedal.

### Drawing

Preferred exemplary embodiments of the invention are described in detail below, referring to the accompanying drawing. Identical or functionally equivalent parts are each denoted by the same reference numerals. In the drawing:

FIG. 1 shows a schematic view of an active accelerator pedal according to a first exemplary embodiment of the invention,

FIG. 2 shows a schematic view of an active accelerator pedal according to a second exemplary embodiment of the invention,

FIG. 3 shows an exploded representation of an active accelerator pedal according to a third exemplary embodiment of the invention,

FIG. 4 shows a sectional view of the active accelerator pedal in FIG. 3,

FIG. 5 shows a schematic view of an active accelerator pedal according to a fourth exemplary embodiment of the invention and

FIG. 6 shows a schematic top view of the active accelerator pedal in FIG. 5.

### Preferred embodiments of the invention

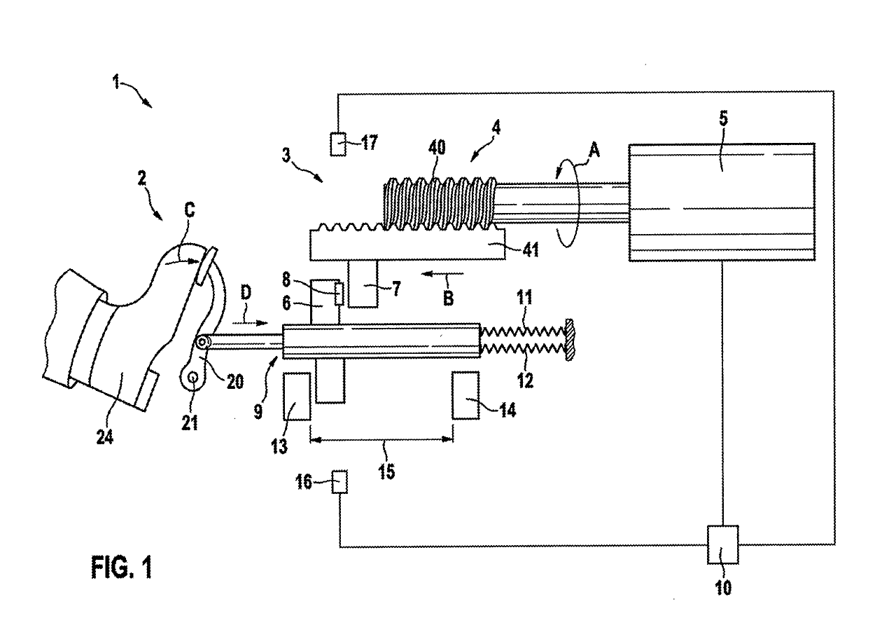

An active accelerator pedal 1 according to a first preferred exemplary embodiment of the invention is described in detail below, referring to FIG. 1.

As can be seen from FIG. 1, the active accelerator pedal 1 comprises a peal unit 2 and an actuator unit 3. The demarcation between the pedal unit 2 and the actuator unit 3 is defined by a first stop 6 of the pedal unit and a second stop 7 of the actuator unit.

The pedal unit 2 comprises a pedal 20, which can be actuated by means of a foot 24, for example. The pedal may also be actuated in an entirely different way, however, for example by hand or by a robot, which functions as “driver” and comprises sensors for determining the counterforce. The pedal 20 is capable of pivoting about a pivot axis 21. An upright pedal is represented in this exemplary embodiment, but a pendent pedal may also be used. The pedal 20 is connected to a first and second return element 11, 12 (for safety reasons of redundant design) by way of a linkage arrangement 9. A maximum pedal travel 15 is defined between an idling stop 13 and a full-load stop 14 (cf. FIG. 1).

A first travel sensor 16 registers a position of the pedal 20 via a displacement travel of the linkage arrangement 9.

The actuator unit 3 comprises an electrical drive 5 and a worm gear 4. The worm gear is of single-step design and has a predefined irreversibility. The worm gear 4 comprises a worm 40 and a driven worm element 41, which in FIG. 1 is represented only schematically as a rack. A second stop 7 is arranged on the driven worm element 41. The first stop 6 is arranged on the linkage arrangement 9. A second travel sensor 17 determines a position of the worm element 41.

In normal operation a driver operates the pedal 20 with his foot 24, so that a control unit 10 controls a drive of the vehicle as a function of the pedal travel or the pedal position, which can be registered by means of the first travel sensor 16. The actuator unit 3 here is in an unactivated state, fully retracted, so that the first stop 6 of the pedal unit 2 cannot come into contact with the second stop 7 of the actuator unit 3.

If an active accelerator pedal is now required, for example in a fuel-economy setting for the vehicle, the electrical drive 5 is actuated via the control unit 10 (arrow A), so that the second stop 7 is moved by the worm gear 6 in the direction of the arrow B. As soon as the first stop 6 comes into contact with the second stop 7, a counterforce is generated, which the driver consciously perceives on the pedal 20. For damping the contact, an elastomer element 8 is provided between the first stop 6 and the second stop 7. The counterforce generated ranges from 10 to 15 N, for example.

The driver can then depress the pedal 20 only so far (arrow C), until the linkage arrangement 9 has traversed to such a degree (arrow D) that the stop 6 comes into contact with the stop 7. If the driver presses more heavily on the pedal, the irreversibility of the worm gear 4 is overcome, so that the stop 6 moves the worm element 41 in the opposite direction to the direction of movement B and in opposition to the counterforce applied.

It should be noted that the actuator unit 3 acts only in the direction of the arrow B, so that the actuator unit cannot exert an acceleratory action but is capable of acting on the pedal 20 with a force only in the direction of the idling position.

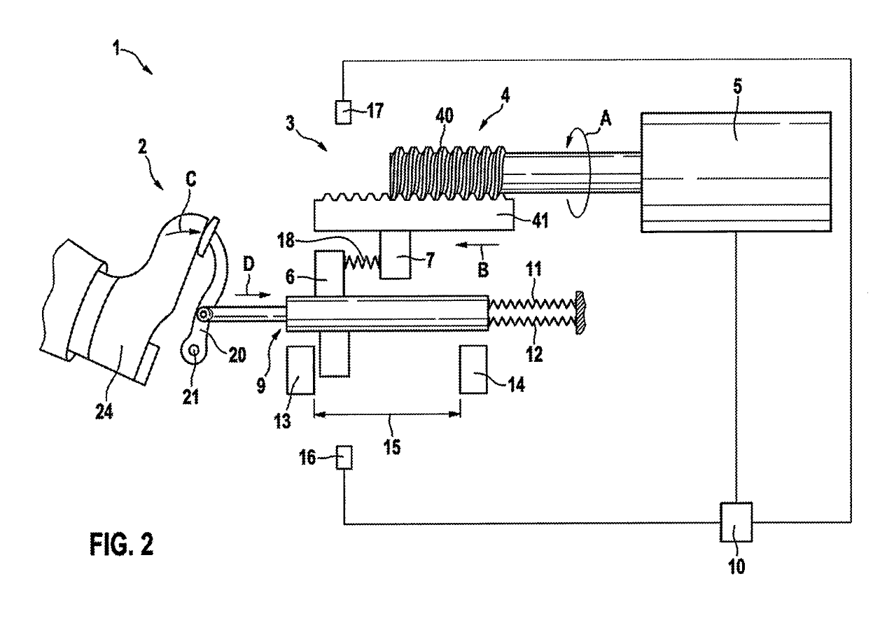

FIG. 2 shows an active accelerator pedal 1 according to a second exemplary embodiment of the invention. The second exemplary embodiment corresponds substantially to the first exemplary embodiment, wherein in contrast to the first exemplary embodiment a coupling spring 18 is arranged between the first stop 6 and the second stop 7 In this exemplary embodiment the coupling spring is a linear compression spring. Since the pedal unit 2 and the actuator unit 3 move independently of one another, and the respective positions are registered by means of the first travel sensor 16 and the second travel sensor 17 respectively, the resulting counterforce, which a driver additionally senses on the pedal 20, is a measure, depending on the spring characteristic, of a tensioning of the coupling spring 18. Since the positions are determined by means of the travel sensors, it is therefore possible to adjust the required counterforce through the pedal position or the actuator position. As a result, the force adjustment of the counterforce may be reduced to a pure positional control. In addition, the coupling spring 18 also brings about a damping of oscillations or the like, which might give rise to an unpleasant sensation for the driver on the pedal 20.

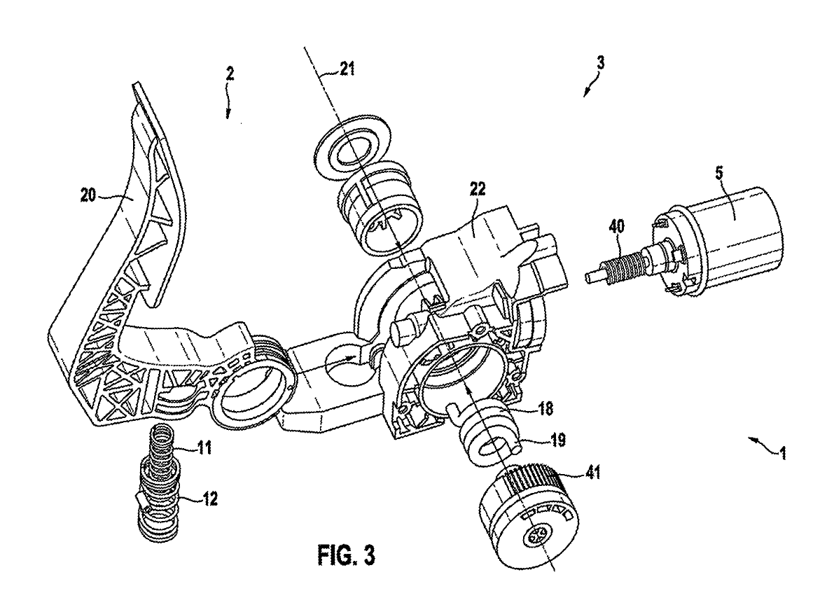

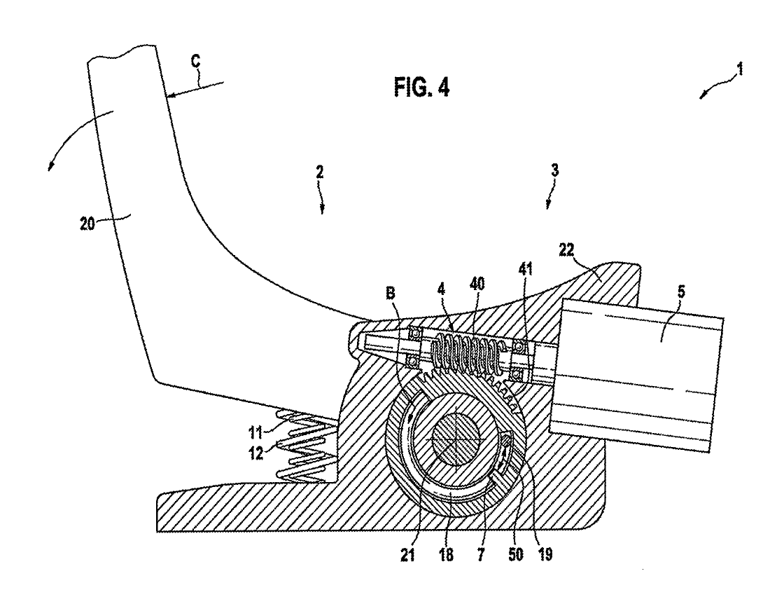

An active accelerator pedal according to a third exemplary embodiment of the invention is described in detail below, referring to FIGS. 3 and 4.

The third exemplary embodiment in the main corresponds to the second exemplary embodiment, wherein a coupling spring 18 is again provided between the pedal unit 2 and the actuator unit 3. In the third exemplary embodiment, however, the coupling spring 18 is embodied as a cylindrical torsion spring. A worm element 41 embodied as a worm wheel is still arranged coaxially with a pivot axis 21 of the pedal 20 (FIG. 4). The worm element 41 here is arranged entirely in a housing 22 of the pedal unit 2.

As can further be seen from FIG. 4, this exemplary embodiment also has a free travel 50. The free travel ensures that the actuator unit 3 first has to be operated over a predefined distance until a counterforce can be generated in opposition to a pedal movement. Only when a spring end 19 comes into contact with a stop 7 on the worm element 41 (cf. FIG. 4) is the counterforce generated by the actuator unit 3. As can be seen from FIGS. 3 and 4, this development according to the invention is of a particularly compact construction. The worm 40 of the worm gear 4 is also arranged entirely in the housing 22 of the pedal unit 2.

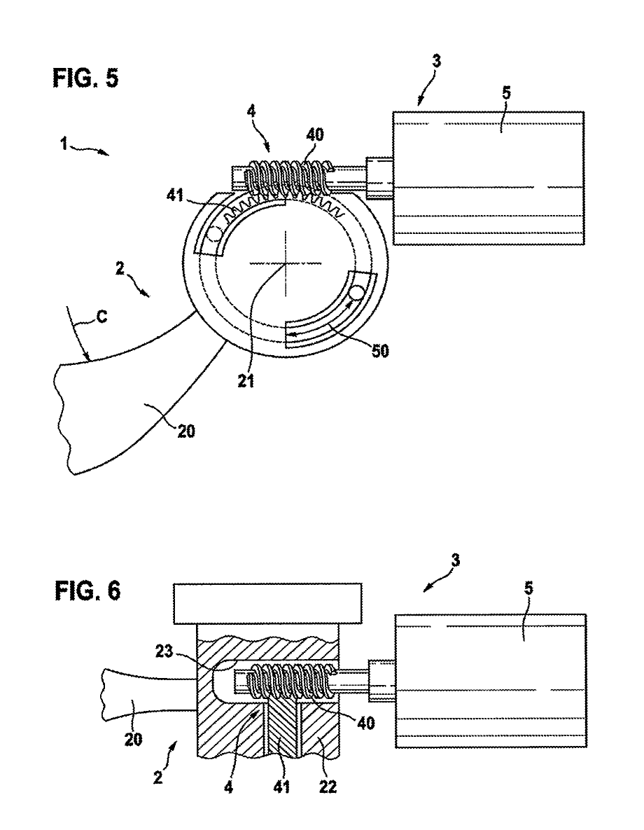

FIGS. 5 and 6 show an active accelerator pedal 1 according to a fourth exemplary embodiment of the invention. In this exemplary embodiment a free travel 50 is again provided between the pedal unit 2 and the actuator unit 3. A window 23 is furthermore provided in the housing 22 of the pedal unit 2. The window 23 here serves to allow the worm 40, which partially projects into the window 23, to mesh with the worm element 41 embodied as a worm wheel. This provides an especially compact housing 22 of the pedal unit 2. The solution with the window 23 in the housing 22 furthermore allows the pedal unit 2 in each case to be easily adapted to different vehicle manufacturers by simply providing a different housing with a different position of the window 23, and positioning the electrical drive 5 accordingly.

1. An active accelerator pedal for a vehicle, comprising:
a pedal unit including a pedal that is pivotable about a pivot axis; and
an actuator unit including an electrical drive and a worm gear positioned between the electrical drive and the pedal unit, the worm gear having a worm and a driven worm element, and the actuator unit configured to apply a counterforce in a direction opposite to a pedal force exerted on the pedal.

2. The accelerator pedal as claimed in claim 1, wherein the worm gear is a single-step worm gear, and includes at most one worm and at most one worm wheel.

3. The accelerator pedal as claimed in claim 1, wherein the worm element comprises a worm wheel.

4. The accelerator pedal as claimed in claim 3, wherein the pivot axis of the pedal is coaxial with a central axis of the worm wheel.

5. The accelerator pedal as claimed in claim 1, wherein:
the pedal unit further includes a first stop; and
the actuator unit further includes a second stop configured to transmit the counterforce applied by the actuator unit to the pedal unit.

6. The accelerator pedal as claimed in claim 1, further comprising a spring element positioned between and operatively connected to the worm gear and the pedal.

7. The accelerator pedal as claimed in claim 6, wherein the spring element includes a compression spring or a torsion spring.

8. The accelerator pedal as claimed in claim 1, further comprising a first travel sensor and a second travel sensor, wherein:
the actuator unit further includes a moveable component of the actuator unit;
the first travel sensor is configured to determine a position of the moveable component, of the actuator unit; and
the second travel sensor is configured to determine a position of the pedal.

9. The accelerator pedal as claimed in claim 1, wherein:
the worm gear and the pedal unit define a free travel; and
the actuator unit is configured to apply the counterforce to the pedal unit in a direction opposite to the pedal force in response to a movement of the actuator unit a distance defined by the free travel.

10. The accelerator pedal as claimed in claim 1, further comprising:
a housing, wherein:
the worm element is positioned in the housing;
the housing has includes a window; and
the worm engages the worm element through the window.

11. The accelerator pedal as claimed in claim 6, wherein:
the spring element includes a spring end;
the worm gear includes a stop;
the spring end and the stop define a free travel; and
the actuator unit is configured to apply the counterforce to the pedal unit in a direction opposite to the pedal force in response to a movement of the actuator unit a distance defined by the free travel.

12. The accelerator pedal as claimed in claim 1, further comprising a control unit configured to operate the actuator unit, wherein the actuator unit is configured to apply a counterforce in a direction opposite to a pedal force exerted on the pedal in response to signals from the control unit.

13. The accelerator pedal as claimed in claim 8, wherein the moveable component of the actuator unit is the worm element.
